(19) United States
(12) Patent Application Publication
(10) Pub. No.: US 2017/0111112 A1
(43) Pub. Date: Apr. 20, 2017

(54) Optically Obtaining Gravitational Field Measurements in a Downhole or Subsea Environment

(71) Applicant: HALLIBURTON ENERGY SERVICES, INC., Houston, TX (US)

(72) Inventors: Luis E. San Martin, Houston, TX (US); Etienne M. Samson, Cypress, TX (US); Satyan G. Bhongale, Cypress, TX (US)

(73) Assignee: HALLIBURTON ENERGY SERVICES, INC., Houston, TX (US)

(21) Appl. No.: 15/311,064

(22) PCT Filed: Jun. 25, 2014
(86) PCT No.: PCT/US2014/044151

§ 371 Date: Nov. 14, 2016

(51) Int. Cl. H04B 10/079; H04B 10/80; H04B 10/25; E21B 49/00; H04B 10/572

(52) U.S. Cl. CPC H04B 10/0795; E21B 49/00; H04B 10/572; H04B 10/2504; H04B 10/80; E21B 47/12

(57) ABSTRACT

A gravitational logging method includes optically obtaining gravitational field measurements from one or more downhole or subsea sensor units. The method also includes inverting the gravitational field measurements as a function of position to determine a formation property. A related system includes one or more downhole or subsea sensor units to optically obtain gravitational field measurements. The system also includes a processing unit that inverts the gravitational field measurements as a function of position to determine a formation property.

### BACKGROUND

During oil and gas exploration and production, many types of information are collected and analyzed. The information is used to determine the quantity and quality of hydrocarbons in a reservoir, and to develop or modify strategies for hydrocarbon production. Previous downhole data collection and analysis techniques do not appear to have adequately addressed gravitational field monitoring and analysis issues. Efforts to improve and to efficiently obtain meaningful information from gravitational field monitoring are ongoing.

### BRIEF DESCRIPTION OF THE DRAWINGS

Accordingly, there are disclosed herein techniques for optically obtaining gravitational field measurements in a downhole or subsea environment. In the drawings:

FIGS. 1A-1F shows illustrative gravitational field survey environments.

FIGS. 2A-2G show illustrative gravitational field logging sensor configurations.

FIG. 3 shows an optical frequency multiplexing process.

FIG. 4 shows an optical array of sensor units in a unidirectional configuration.

FIG. 5 shows an optical array of sensor units in a bidirectional configuration.

FIG. 6 shows a flowchart of an illustrative gravitational logging control process.

FIG. 7 shows a flowchart of an illustrative gravitational log inversion process.

FIG. 8 shows a flowchart of an illustrative gravitational logging method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

Disclosed embodiments are directed to gravitational logging methods and systems that optically obtain gravitational field measurements using one or more downhole or subsea sensor units and that invert the gravitational field measurements as a function of position (e.g., a three-dimensional coordinate position) to determine a formation property. If one sensor unit is used to obtain the gravitational field measurements as a function of position, repositioning of the sensor unit is possible, for example, via logging-while-drilling (LWD) operations, wireline logging operations, or subsea sensor cable adjustments. Multiple sensor units may similarly be repositioned via logging-while-drilling (LWD) operations, wireline logging operations, or subsea sensor cable adjustments. Alternatively, one or more sensor units may be permanently positioned in a downhole or subsea environment.

As used herein, “permanent” refers to a period of time suitable for downhole or subsea monitoring operations. While such monitoring operations are intended to occur over a period of weeks, months, or years, shorter monitoring intervals are possible. Further, permanent may also refer to a condition that is difficult to reverse. Thus, a sensor unit deployed for a monitoring interval using a wireline string, a tubing string, or a subsea cable is an example of a permanently positioned sensor unit even though the wireline string, tubing string, or subsea cable is easy to retrieve. Further, a sensor unit that is bonded to or otherwise secured to casing of a well installation is an example of a permanent gravitational sensor array due to the difficulty of reversing the deployment, especially if the sensor unit is cemented in place. In some embodiment, combinations of repositionable sensor units and permanently positioned sensor units may be used to obtain the gravitational field measurements as a function of position.

The position information used for the inversion can be determined, for example, by correlating with openhole logs. Further, in some embodiments, the position of a sensor unit can be determined if the position of another sensor (e.g., another gravitational field sensor unit or possibly another type of sensor) is known or determinable (e.g., the offset between the gravitational field sensor and the other is known). Once the position of one gravitational field sensor unit has been determined, the position of other gravitational field sensor units with known offsets from each other can be determined. The degree of inaccuracy in the position of the gravitational field sensor unit will transfer to a degree of inaccuracy in the results of the inversion. Further, in some embodiments, one or more tools can be deployed in a borehole to determine the position of sensor units by emitting a source signal and by analyzing a response signal from the sensor units. In such case, the position of the tool is known, and the position of the sensor units are deduced from the response signals. In a subsea scenario, GPS and low frequency electromagnetic (EM) signals can be used to determine the position of sensors units.

In accordance with at least some embodiments, the gravitational field sensor units are monitored or interrogated via one or more fiber optic cables, where the monitoring/interrogation interface is located at earth's surface. With fiber optic monitoring or interrogation, the number of downhole or subsea electronic components is reduced, resulting in increased reliability and lower cost compared to an electrical monitoring or interrogation.

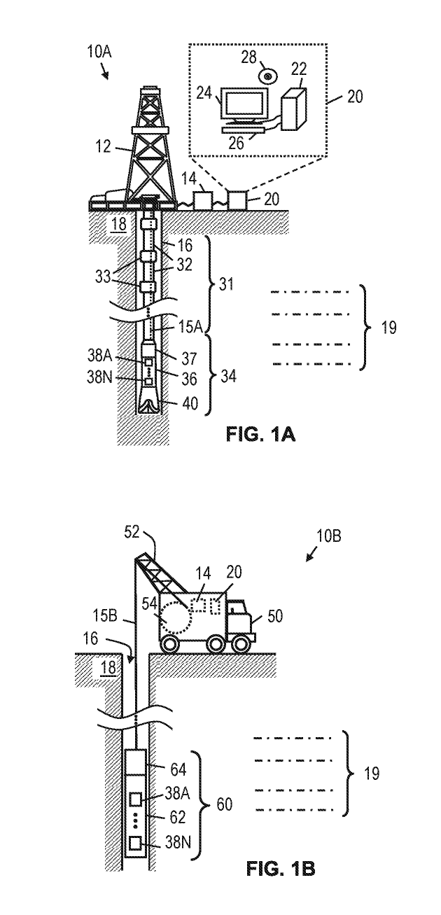

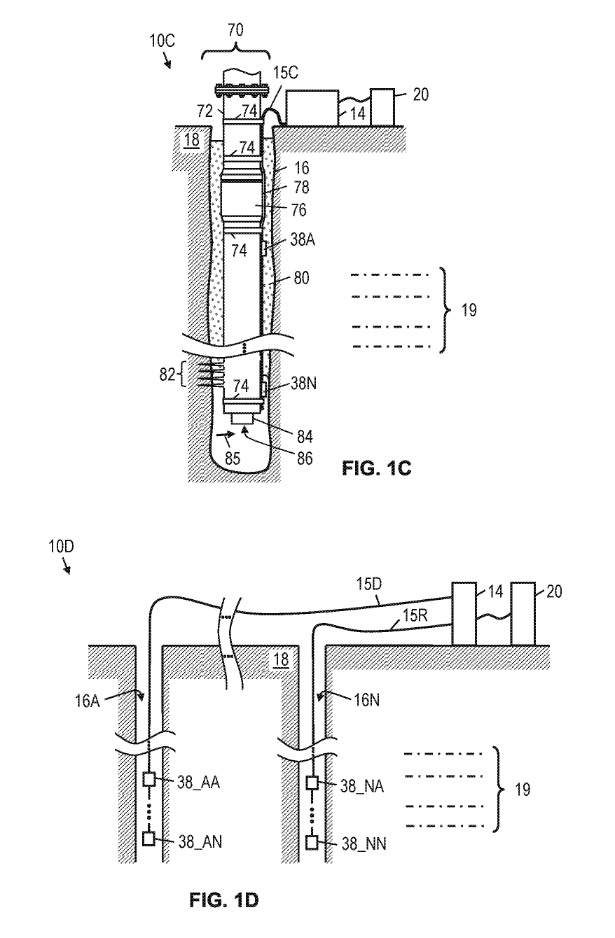

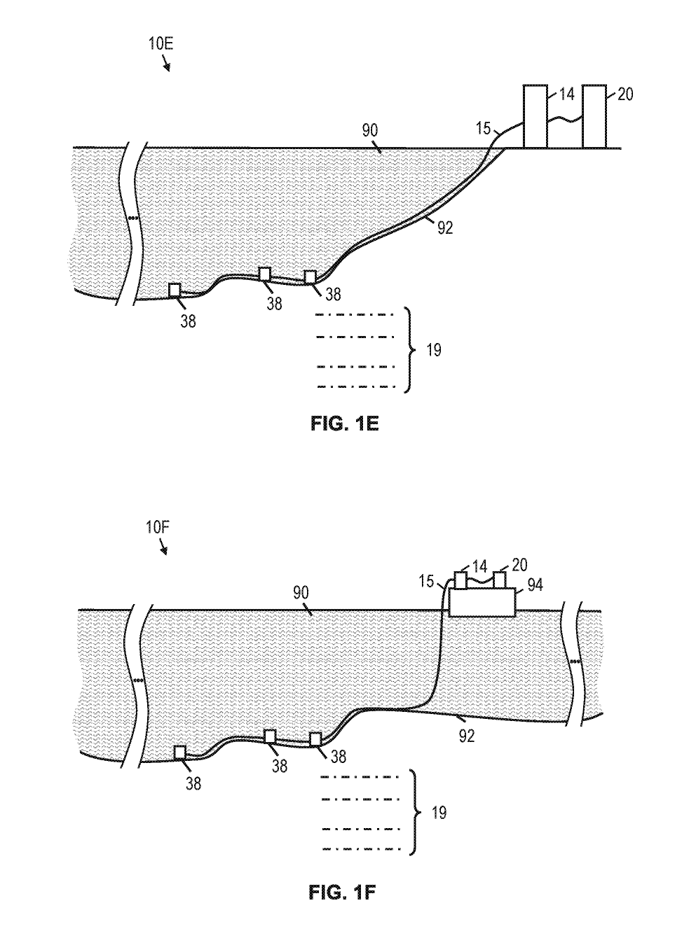

FIGS. 1A-1F show illustrative gravitational field survey environments including LWD, wireline logging, permanent well installations, and subsea survey environments. FIG. 1A shows an illustrative LWD survey environment 10A. In FIG. 1A, a drilling assembly 12 enables a drill string 31 to be lowered and raised in a borehole 16 that penetrates formations 19 of the earth 18. The drill string 31 is formed, for example, from a modular set of casing segments 32 and adaptors 33. At the lower end of the drill string 32, a bottomhole assembly 34 with a drill bit 40 removes material from the formation 18 using known drilling techniques. The bottomhole assembly 34 also includes one or more drill collars 37 and a logging tool 36 with one or more sensor units 38A-38N to optically obtain gravitational field measurements as described herein.

In at least some embodiments, one or more of the sensor units 38A-38N is positioned near the drill bit 40 to obtain gravitational field measurements near the drill bit 40 (e.g., look-around or look-ahead logging). Such positioning is possible, for example, by integrating the logging tool 36 with a drill collar 37 close to drill bit 40. The drilling operations of the drilling assembly 12 and bottomhole assembly 34 are preferably halted while gravitational field measurements are collected by sensor units 38A-38N. Otherwise, movement of the sensor units 38A-38N as obtain gravitational field measurements are collected should be accounted for. With gravitational field measurements collected near the drill bit 40, steering decisions for the LWD survey environment 10A may be based at least in part on the collected gravitational field measurements nod/or formation density estimates based on the collected gravitational field measurements. If the spacing between multiple sensor units 38A-38N is small (e.g., if multiple sensor units are integrated with a single drill collar), the variation in gravitational field measurements will likely be negligible, but error correction and accuracy can be increased.

The logging tool 36 may also include electronics for data storage, communication, etc. The gravitational field measurements obtained by the one or more sensor units 38A-38N are conveyed to earth's surface and/or are stored by the logging tool 36. In either case, gravitational field measurements as a function of position may be inverted to determine a property of formation 18. For example, the gravitational field measurements may be used to derive a density log as a function of position and/or to track movement of reservoir fluids.

In FIG. 1A, an optional cable 15A (a dashed line extending between the bottomhole assembly 34 and earth's surface) is represented. The cable 15A may take different forms and includes embedded electrical conductors and/or optical waveguides (e.g., fibers) to enable transfer of power and/or communications between the bottomhole assembly 34 and earth's surface. The cable 15A may be integrated with, attached to, or inside components of the drill string 31. In at least some embodiments, cable 15A may be supplemented by or replaced at least in part by mud based telemetry or other wireless communication techniques (e.g., electromagnetic, acoustic). The cable 15A is not essential particularly if lasing light is generated downhole. In such case, the lasing light generated downhole could be used to collect gravitational field measurements as described herein, which are then conveyed to earth's surface by known LWD telemetry techniques (e.g., mud, electromagnetic, acoustic telemetry).

In FIG. 1A, an interface 14 at earth's surface receives the gravitational field measurements via cable 15A or another telemetry channel and conveys the gravitational field measurements to a computer system 20. In some embodiments, the surface interface 14 and/or the computer system 20 may perform various operations such as converting signals from one format to another, storing the gravitational field measurements and/or processing the measurements. As an example, in at least some embodiments, the computer system 20 includes a processing unit 22 that performs the disclosed inversion operations by executing software or instructions obtained from a local or remote non-transitory computer-readable medium 28. The computer system 20 also may include input device(s) 26 (e.g., a keyboard, mouse, touchpad, etc.) and output device(s) 24 (e.g., a monitor, printer, etc.). Such input device(s) 26 and/or output device(s) 24 provide a user interface that enables an operator to interact with the logging tool 36 and/or software executed by the processing unit 22. For example, the computer system 20 may enable an operator to select inversion options, to view collected gravitational field measurements, to view inversion results, and/or to perform other tasks.

At various times during the drilling process, the drill string 32 shown in FIG. 1A may be removed from the borehole 16. With the drill string 32 removed, wireline logging operations may be performed as shown in the wireline logging survey environment 10B of FIG. 1B. In FIG. 1B, a wireline logging string 60 is suspended in borehole 16 that penetrates formations 19 of the earth 18. For example, the wireline logging string 60 may be suspended by a cable 15B having conductors and/or optical fibers for conveying power to the wireline logging string 60. The cable 15B may also be used as a communication interface for uphole and/or downhole communications. In at least some embodiments, the cable 15B wraps and unwraps as needed around cable reel 54 when lowering or raising the wireline logging string 60. As shown, the cable reel 54 may be part of a movable logging facility or vehicle 50 having a cable guide 52. As shown, the wireline logging string 60 includes logging tool(s) 64 and a logging tool 62 with one or more sensor units 38A-38N to optically obtain gravitational field measurements. The logging tool 62 may also include electronics for data storage, communication, etc. The gravitational field measurements obtained by the one or more sensor units 38A-38N are conveyed to earth's surface and/or are stored by the logging tool 62. In either case, gravitational field measurements as a function of position may be inverted to determine a property of formation 18. For example, the gravitational field measurements may be used to derive a density log as a function of position and/or to track movement of reservoir fluids.

At earth's surface, a surface interface 14 receives the gravitational field measurements via the cable 15 and conveys the gravitational field measurements to a computer system 20. As previously discussed, the interface 14 and/or computer system 20 (e.g., part of the movable logging facility or vehicle 50) may perform various operations such as converting signals from one format to another, storing the gravitational field measurements and/or processing the measurements.

FIG. 1C shows a permanent well survey environment IOC, where well 70 is equipped with one or more sensor units 38-A-38N for optically obtaining gravitational field measurements. In the permanent well survey environment 10C, a drilling rig has been used to drill borehole 16 that penetrates formations 19 of the earth 18 in a typical manner (see e.g., FIG. 1A). Further, a casing string 72 is positioned in the borehole 16. The casing string 72 of well 70 includes multiple tubular casing sections (usually about 30 feet long) connected end-to-end by couplings 76. It should be noted that FIG. 1C is not to scale, and that casing string 72 typically includes many such couplings 76. Further, the well 70 includes cement slurry 80 that has been injected into the annular space between the outer surface of the casing string 72 and the inner surface of the borehole 16 and allowed to set. Further, a production tubing string 84 has been positioned in an inner bore of the casing string 72.

The well 70 is adapted to guide a desired fluid (e.g., oil or gas) from a section of the borehole 16 to a surface of the earth 18. Perforations 82 have been formed at a section of the borehole 16 to facilitate the flow of a fluid 85 from a surrounding formation into the borehole 16 and thence to earth's surface via an opening 86 at the bottom of the production tubing string 84. Note that this well configuration is illustrative and not limiting on the scope of the disclosure.

In the embodiment of FIG. 1C, a cable 15C having electrical conductors and/or optical waveguides extends along an outer surface of the casing string 72 and is held against the outer surface of the of the casing string 72 at spaced apart locations by multiple bands 74 that extend around the casing string 72. A protective covering 78 may be installed over the cable 15C at each of the couplings 76 of the casing string 72 to prevent the cable 15C from being pinched or sheared by the coupling's contact with the borehole wall. The protective covering 78 may be held in place, for example, by two of the bands 74 installed on either side of coupling 76. In at least some embodiments, the cable 15C terminates at surface interface 14, which conveys gravitational field measurements obtained from the sensor units 38A-38N to a computer system 20.

FIG. ID shows a multi-well survey environment 10D, in which sensor units 38 AA to 38 NN are distributed in multiple boreholes 16A-16N that penetrate formations 19 of the earth 18. The sensor units 38_AA to 38_NN may be positioned in the boreholes 16A-16N via LWD operations (see e.g., FIG. 1A), wireline logging operations (see e.g., FIG. 1B), and/or permanent well installations (see e.g., FIG. 1C). For each of the boreholes 16A-16N, corresponding cables 15D-15R may convey power and/or communications between the sensor units 38_AA to 38_NN and earth's surface. At earth's surface, one or more surface interfaces 14 couple to the cables 15D-15R to receive the gravitational field measurements from the sensor units 38_AA to 38_NN and to convey the gravitational field measurements to computer system 20, where inversion operations are performed as described herein. Before proceeding it should be noted that the sensor units 38A-38N, and 38_AA to 38_NN, as well as the cables 15A-15R may vary for different embodiments. Further, it should be noted that the sensor units 38 and cables 15 may be deployed in a subsea environment rather than a downhole environment. Further, sensor units 38 and cables 15 may be deployed in a subsea well.

FIGS. 1E and 1F show subea gravitational field survey environments 10E and 10F. In the subsea survey environment 10E, a plurality of sensor units 38 are deployed along the seabed 92 of a body of water 90, where one or more cables 15 convey power and/or communications between the sensor units 38 and earth's surface. it should be appreciated that at least some of the sensors units 38 in the body of water 90 are not necessarily at the seabed 92. (Gravitational field measurements can be collected using sensor units 38 located at the seabed 92 and/or at different positions/depths in the body of water 90, etc.). At earth's surface, one or more surface interfaces 14 couple to the cables 15 to receive the gravitational field measurements from the sensor units 38 and to convey the gravitational field measurements to computer system 20, where inversion operations are performed as described herein. As an example, the inversion operations may provide density information regarding formation 19 below seabed 92. In the survey environment 10E, the surface interface 14 and computer system 20 are land-based.

For the subsea survey environment 10F, a plurality of sensor units 38 are similarly deployed along the seabed 92 of a body of water 90, where one or more cables 15 convey power and/or communications between the sensor units 38 and earth's surface. Again, it should be appreciated that at least some of the sensors units 38 in the body of water 90 are not necessarily at the seabed 92. (Gravitational field measurements can be collected using sensor units 38 at the seabed 92 and/or at different positions/depths in the body of water 90, etc.). At earth's surface, one or more surface interfaces 14 couple to the cables 15 to receive the gravitational field measurements from the sensor units 38 and to convey the gravitational field measurements to computer system 20, where inversion operations are performed as described herein. As an example, the inversion operations may provide density information regarding formation 19 below seabed 92. In the subsea survey environment 10F, the surface interface 14 and computer system 20 are located on a platform or vessel 94.

For subsea survey environments such as environments 10E and 10F, the sensor units 38 and the monitoring/interrogation components would be the same or similar as for downhole scenarios, but the deployment scheme would be different. Further, the packaging of sensor units 38 may vary depending on whether the sensors units are used in downhole environment or subsea environment.

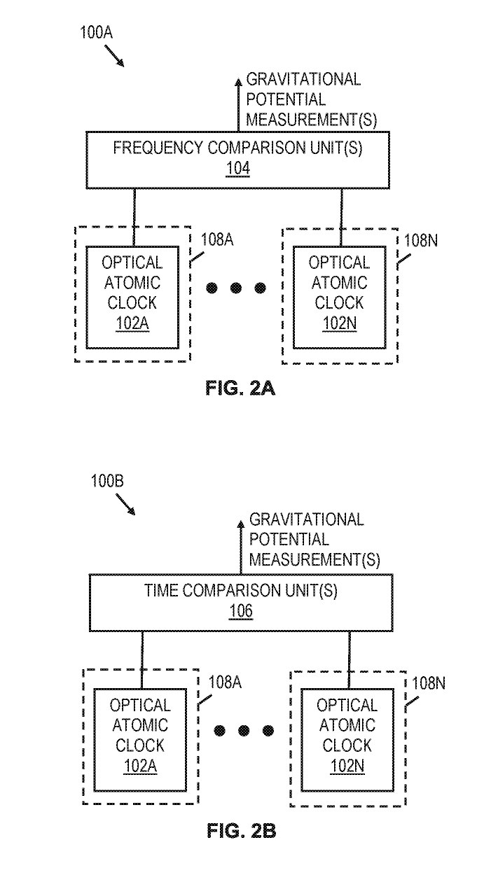

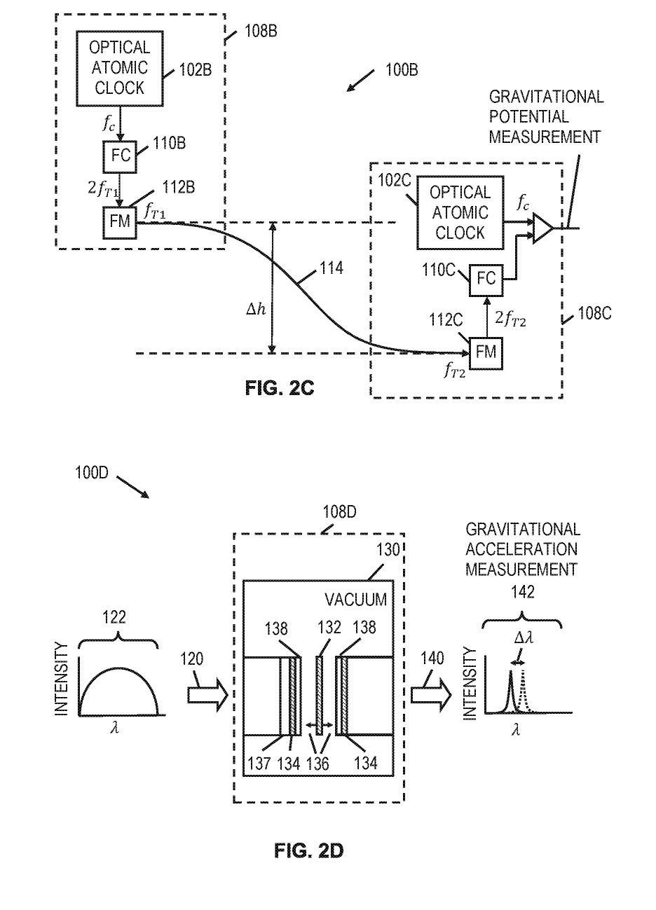

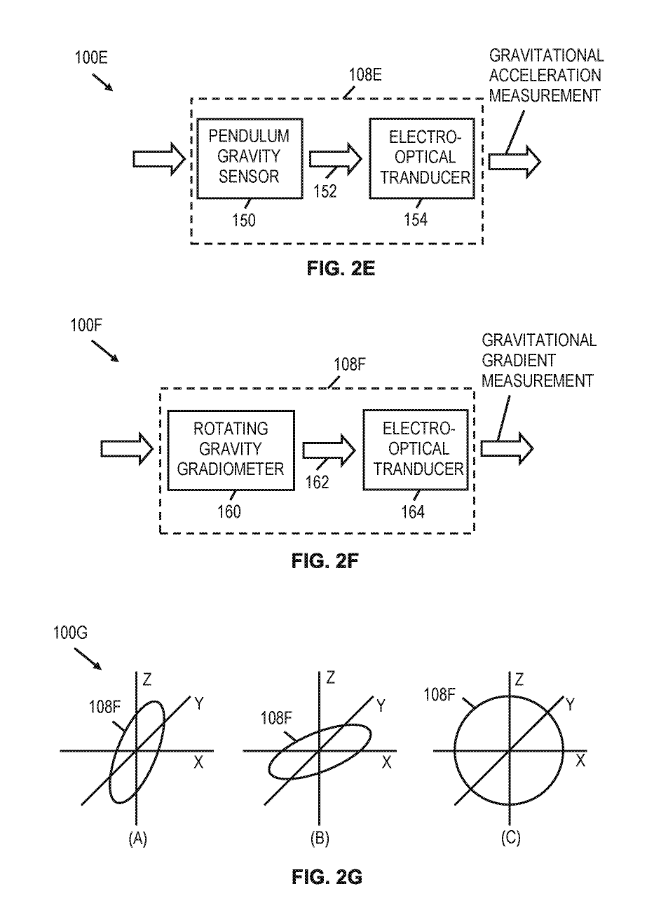

FIGS. 2A-2G show different gravitational field logging sensor configurations with various types of sensor units 108 that correspond to the sensor units 38 of FIGS. 1A-1D. Further, it should be understood that the orientation of some sensor units and/or their respective sensors may vary to detect gravitational field and field derivative measurements in different directions. Further, different cables 15A-15R may support one-way communications or two-way communications. Further, different cables 15A-15R may enable optical signal transmission and/or electrical signal transmission. To optically obtain gravitational field measurements, the sensor units may include one or more sensors that directly output gravitational field measurements as optical signals. Alternatively, sensor units may include one or more sensors that output gravitational field measurements as electrical signals, and one or more electro-optical transducers to convert each electrical signal to a corresponding optical signal. Once a gravitational field measurement has been optically obtained, the corresponding optical signal may be conveyed to earth's surface via a cable with one or more optical fibers. Alternatively, optical signals corresponding to gravitational field measurements may be converted to electrical signals for storage downhole or subsea, and/or for conveyance to earth's surface via an electrical conductor.

One possible sensor for optically obtaining gravitational field measurements is an optical atomic clock. Optical atomic clocks are currently the most stable frequency sources available, vastly surpassing the traditional atomic clocks by several orders of magnitude. For example, frequency uncertainties of 8.6×10⁻¹⁸ have been reported in optical atomic clocks based on a single Al⁺ ion. See e.g., Chou et al., Frequency Comparison of Two High-Accuracy Al⁺ Optical Clocks, Physical Review Letters, Vol. 104, 070802 (2010). Other example optical atomic clocks are described in R. Le Targat et al., Experimental Realization of an Optical Second with Strontium Lattice Clocks, Nature Communications 4, Article No. 2109 (2013), and N. Hinkley et al., An Atomic Clock with 10′ Instability, Science, Vol. 341, pages 1215-1218 (2013). Such clocks may be configured to produce a light beam having a carrier frequency that is locked to the clock, or alternatively a light beam that pulses at a rate that is locked to the clock.

In accordance with general relativity, gravitational field strength affects the rate at which a clock registers time. Thus, the larger the gravitational field, the slower the clock. From this effect it can be concluded that the gravitational potential, g, as a function position can be determined by comparing different clock frequencies or times, where the clocks are located at different positions.

FIG. 2A shows an illustrative gravitational field logging sensor configuration 100A for optically obtaining gravitational potential measurements. As shown, the configuration 100A includes a plurality of sensor units 108A-108N, each with a respective optical atomic clock 102A-102N. Each optical atomic clock may correspond to an optical clock that uses a laser to probe transitions in isolated atoms. Example optical atomic clocks have used, for example Sr or Al ion atoms to achieve increased accuracy levels compared to cesium atomic clocks. Each of the optical atomic clocks 102A-102N include, for example, quantum logic spectroscopy (QLS) components, laser cooling components, and/or other components to enable transitions of an isolated atom to be counted and used as a clock signal. At the same position, the frequency of each optical atomic clock 102A-102N is the same to within a known error threshold.

However, when the optical atomic clocks 102A-102N are distributed in a downhole or subsea environment, their frequencies will be affected by gravitational field variations due to depth variation and/or proximity to materials with different densities.

Accordingly, for configuration 100A, the optical atomic clocks 102A-102N are distributed or repositioned and their frequencies as a function of position are compared by frequency comparison unit(s) 104. The frequency comparison unit(s) 104 may include interferometer components, frequency comb components, frequency multiplier components, and/or other components to enable high-precision frequency comparisons, as well as a reference frequency from an atomic optical clock at the surface. In at least some embodiments, the frequency comparison unit(s) 104 is separate from the sensor units 108A-108N as shown.

As an example, the frequency comparison unit(s) 104 may be part of a surface interface (e.g., surface interface 14), a bottomhole assembly (e.g., bottomhole assembly 34), a wireline logging string (e.g., wireline logging string 60), or a subsea umbilical. Alternatively, it should be appreciated that a frequency comparison unit 104 could be included with one or more of the sensor units 108A-108N.

The equation that relates height above the surface of the earth and frequency shift due to general relativistic effects is given as:

$$\frac{δ f}{{f}_{0}} = \frac{g \times Δ h}{{c}^{2}} , \qquad Equation ( 1 )$$

where δf is the shift in the clock transition frequency, f₀ is the frequency of the transition at a first position, and Δh is the difference in height between the first position and a second position (assuming that the gravitational potential only depends on the height), with c being the speed of light. In situations where the gravitational potential depends on other factors, for example, the density of formation, then the corresponding dependence should be used in the above formula. See C. W. Chou et. al, Optical Clocks and Relativity, Science, Vol. 329, pages 1630-1633 (2010). From Equation 1, a change in

$$\frac{δ f}{{f}_{0}}$$

per Gal (unit of gravity) enables evaluation of gravitational strength. For example, a change of ˜10⁻¹⁸ in the ratio in

$$\frac{δ f}{{f}_{0}}$$

is equivalent to approximately 3 μGal, which above a homogeneous earth formation is equivalent to a difference in height of approximately 1 centimeter.

The signal from the two clocks can be analyzed by interferometric methods to determine the difference in frequencies. To improve results, sources of error may be accounted for to, e.g., determine and cancel the portion of the shift that is due to gravitational field variation as a function of position. One source of error is Doppler shift due to thermal agitation. This error can be cancelled, for example, by probing optical atomic clock transitions with light from two opposite directions, which causes Doppler shifts in opposite directions that can be cancelled by combining the two measurements. Another source of error is the noise of the source laser used to probing optical atomic clock transitions. This error can be drastically mitigated by using noise feedback loop cancellation techniques. See e.g., K. Predehl et al., A 920-Kilometer Optical Fiber Link for Frequency Metrology at the 19^{th} Decimal Place, Science, Vol. 336, pages 441-444 (2012). Further, in order to achieve sufficient signal level the measurement may have to include a large number of frequency cycles. See e.g., C. W. Chou et. al, Optical Clocks and Relativity, Science, Vol. 329, pages 1630-1633 (2010), and N. Hinkley et al., An Atomic Clock with 10⁻¹⁸ Instability, Science, Vol. 341, pages 1215-1218 (2013).

In at least some embodiments, the frequency comparison unit(s) 104 combine the signals from two optical atomic clocks in an interferometer to extract the frequency shift. The output of the frequency comparison unit(s) 104 can be used to determine a gravitational potential measurement. More specifically, the frequency shift provides a measure of the difference in gravitational potential at the positions of the distributed or repositioned optical atomic clocks 102A-102N. The output of the frequency comparison unit(s) 104 may be provided periodically or upon request to surface interface 14. In some embodiments, a single reference atomic optical clock at the surface can he compared with some or all downhole or subsea sensor units.

FIG. 2B shows another gravitational field logging sensor configuration 100B for optically obtaining gravitational potential measurements. The configuration 100B is similar to the configuration 100A, in that sensor units 108A-108N with respective optical atomic clocks 102A-102N are distributed or repositioned in a downhole or subsea environment. However, rather than compare optical atomic clock frequencies as a function of position as in configuration 100A, the configuration 100B compares optical atomic clock time readings as a function of position. To perform the time comparisons, the configuration 100B includes time comparison unit(s) 106. For example, the time comparison unit(s) 106 may include optical-electro transducers to convert clock transitions to electrical signals that are counted, stored, and/or otherwise registered to enable a time comparison of optical atomic clocks as a function of position. In at least some embodiments, the time comparison unit(s) 106 is separate from the sensor units 108A-108N as shown. As an example, the time comparison unit(s) 106 may be part of a surface interface (e.g., surface interface 14), a bottomhole assembly (e.g., bottomhole assembly 34), or a wireline logging string (e.g., wireline logging string 60). Alternatively, it should be appreciated that a time comparison unit 106 could be included with one or more of the sensor units 108A-108N.

The difference in the time readings between optical atomic clocks at different positions is related to the difference in gravitational potential at their respective positions. This time difference is given as:

$$Δ t = {t}_{B} - {t}_{A} = \frac{\vert {X}_{B} - {X}_{A} \vert}{c} + {( Δ t )}_{G} + {( Δ t )}_{ω} , \qquad Equation ( 2 )$$

where X_{B}, X_{A} are position coordinates of different optical atomic clocks, c is the speed of light, and (Δ,t)_{G}, (Δt)ω is the contribution arising from the gravitational potential and earth's rotation respectively. As needed, the transmission of optical signals from the optical atomic clocks 102A-102N for time comparison operations and/or the transmission of output signals from the time comparison unit(s) 106 can be accomplished by deploying one or more fiber optic cables.

The frequency comparison technique of configuration 100A and the time comparison technique of configuration 100B have notable differences. For example, for frequency comparisons, a sufficiently long measurement time is necessary to accumulate sufficient statistics to reduce the uncertainty of the frequency difference measurement. Further, for frequency comparisons, the optical atomic clocks involved need only be active at measurement time. Meanwhile, for time comparisons, a time reading for each optical atomic sensor needs to be recorded and transmitted. Accordingly, recorded times need to be collected accurately and for a long enough period to accumulate a significant difference. Further, the time comparisons need to be repeated with sufficient frequency to be able to derive the change in gravitational potential as a function of time.

At least some embodiments, both of the configurations 100A and 100B involve transmission of electromagnetic signals between two spatially separated clocks. In both configurations 100A and 100B, optical signals generated by the optical atomic clocks 102A-102N may have a wavelength in the vicinity of 700 nm (a convenient optical clock frequency). If such optical signals are to be transmitted over several kilometers of distance, the attenuation of the optical signals in a fiber should be considered. For modern optical fibers, optical signals between 700 nm to 1800 nm have attenuation below 5 dB/km, which is viable for the intended signal transmissions in the range of a few kilometers. However, optical signals below 700 nm are less convenient because of increased attenuation in the fiber.

Regardless of the optical signal wavelength output from the optical atomic clocks 102A-102N or other components, it should be appreciated that optical frequency combs may be employed to alter the wavelength so that attenuation of signal transmission is reduced. For example, an optical frequency comb may be used in the configurations 100A or 100B to alter the wavelength of signals output from optical atomic clocks 102A-102N to around 1550 nm (telecom wavelengths). More specifically, an optical frequency comb takes an input frequency fᵢₙ and converts it to an output frequency fₒᵤₜ. The signal with frequency fᵢₙ is phase locked to the optical frequency comb, and a telecom laser is phase locked with the optical frequency comb via a frequency doubled signal such that f_{telecom}=fₒᵤₜ/2. In some embodiments, an optical comb in employed for both transmitter and receiver sides. At the transmitter side, the optical frequency comb convert optical atomic clock wavelengths to telecom wavelengths. At the receiver side, the reverse operation is performed. For example, the clock laser (in the case of Strontium, 698 nm) is phase locked to the corresponding tooth of the optical frequency comb, and the telecom laser (1538 nm) is phase locked to the optical frequency comb via the frequency doubled light (769 nm). In this manner, the lasers for probing optical atomic clock transitions are indirectly phase locked to a telecom laser.

FIG. 2C shows another gravitational field logging sensor configuration 100C. In configuration 100C, two sensor units 108B and 108C are shown to include respective optical atomic clocks 102B and 102C. Further, each of the sensor units 108B and 108C includes respective frequency combs 110B, 110C and frequency multipliers 112B, 112C. In alternative embodiments, the frequency combs 110B, 110C and frequency multipliers 112B, 112C may be separate from the sensor units 108B and 108C. The frequency combs 110B, 110C are used to alter the wavelength of signals output from the optical atomic clocks 102B and 102C to enable transmission of optical signals over longer distances as described herein. For example, an optical signal output related to sensor unit 108B may be transmitted to sensor unit 108C via optical fiber 114, which extends between the positions (e.g., Δh) of sensor units 108B and 108C. The dependence of the gravitational potential on Δh is just an example, and other dependence is possible. If Δh=0, then the comparison of the gravitational potential between 108B and 108C will provide information about, for example, the formation density.

Another type of sensor that could be used to optically obtain gravitational field measurements is a pendulum whose position is monitored by a laser beam. This type of sensor has similarities to other available sensors that use pendulums and electrical capacitance measurements to monitor a pendulum's period and maximum amplitude. See e.g., U.S. Pat. App. Pub. No. 20080295594. The pendulum period and maximum angular amplitude are related to the local value of gravity as follows:

$$T = 4 \sqrt{\frac{L}{g}} K [ Sin ( \frac{{θ}_{0}}{2} ) ] , \qquad Equation ( 3 )$$

where T is the period of the movement, L is the length, g the local value of gravity, θ₀ is the maximum oscillation amplitude of the pendulum, and K is the complete elliptic integral of the first kind. In a known configuration, the pendulum may be in the form of a plate that oscillates between two other plates. The movement of the pendulum plate changes the coupling capacitance between the pendulum and the other plates, which is measured precisely. This type of pendulum sensor can be combined with an electro-optical transducer to optically obtain gravitational field measurements (see e.g., FIG. 2E).

FIG. 2D shows a gravitational field logging sensor configuration 100D, which employs an optically-monitored pendulum gravity sensor 130. As shown, configuration 100D includes a sensor unit 108D with the optically-monitored pendulum gravity sensor 130. The sensor 130 includes various components in a vacuum. More specifically, the sensor 130 includes a pendulum 132 within a resonant optical cavity 136 defined by the position of metal plates 134 (e.g., blue plates), where movement of the pendulum changes to the size of the resonant optical cavity 136 resulting in resonant frequency shifts. The impinging light will transfer some momentum to the pendulum 132, but this effect can be cancelled by passing light beams in opposite directions. With both beams providing complementary measurements that can improve the accuracy of the measurement.

For the configuration 100D, the metal plates 134 may have an optical coating 138 (e.g., a yellow coating) on the side that faces the pendulum 132. Likewise, the pendulum 132 may have an optical coating (not shown). Further, the optically-monitored pendulum gravity sensor 130 may include a reference mirror 137. In operation, a light beam 120 having a wide spectrum 122 is input to the sensor 130. The output of the sensor 130 corresponds to a light beam 140 having a shifted wavelength 142 relative to the resonant frequency of the optical resonant cavity 136. The shifted wavelength 142 can be correlated to movement of the pendulum, which is affected by the local gravitational field strength. The light beam 140 is conveyed to earth's surface, for example, via one or more optical fibers whereby gravitation field measurements as a function of position are collected.

FIG. 2E shows a gravitational field logging sensor configuration 100E, which employs a pendulum gravity sensor 150. In configuration 100E, the pendulum gravity sensor 150 as well as an electro-optical transducer 154 reside in sensor unit 108E. The pendulum gravity sensor 150 corresponds to a known type of pendulum sensor (see e.g., U.S. Pat. App. Pub. No. 20080295594), where the output 152 of the pendulum gravity sensor 150 is provided to electro-optical transducer 154 for conversion to an optical signal. The output from the sensor unit 108E corresponds to a gravitational acceleration measurement that can be conveyed to earth's surface via an optical fiber.

FIG. 2F shows a gravitational field logging sensor configuration 100F, which employs a rotating gravity gradiometer 160. In configuration 100F, the rotating gravity gradiometer 160 as well as an electro-optical transducer 164 reside in sensor unit 108F. The rotating gravity gradiometer 160 corresponds to a known type of gradiometer sensor (see e.g., U.S. Pat. No. 5,357,802), where the output 162 of the rotating gravity gradiometer 160 is provided to electro-optical transducer 164 for conversion to an optical signal. The output from the sensor unit 108F corresponds to a gravitational gradient measurement that can be conveyed to earth's surface via an optical fiber.

FIG. 2G shows a gravitational field logging sensor configuration 100G, which employs sensor units 108F (each with a rotating gravity gradiometer 160) in different orientations. More specifically, part (A) of FIG. 2G shows a first sensor unit 108E (and corresponding rotating gravity gradiometer 160) aligned with a Y-Z plane. Meanwhile, part (B) of FIG. 2G shows a second sensor unit 108F (and corresponding rotating gravity gradiometer 160) aligned with an X-Y plane. Finally, part (C) of FIG. 2G shows a third sensor unit 108F (and corresponding rotating gravity gradiometer 160) aligned with an X-Z plane. By orienting different sensor units 108F along different (orthogonal) planes, a complete set of gravitational gradient measurements as a function of position is possible. Even if the planes are not orthogonal, a complete set of gravitational gradient measurements can be generated as long as the planes are not linearly dependent of each other.

It should be noted that the packaging for the various sensor units (e.g., sensor units 108A-108N) described herein may vary depending on the type of gravity sensor used and the inclusion of other components. Further, the packaging of sensor units may vary depending on the downhole or subsea deployment mechanism (e.g., LWD operations, wireline logging operations, permanent well installation operations, or subsea cable) for each sensor unit. In at least some embodiments, the sensor units (e.g., sensor units 108A-108N) described herein are coupled to a fiber optic system. In an example fiber optic system, an interrogation light pulse is sent from the surface to a sensor via an optical fiber. When the pulse reaches the sensor, the light pulse is modified by the sensor, where the modified light pulse encodes measurement information. The modified light pulse is conveyed to earth's surface using the same or different optical fiber, and the measurement information is thereafter processed.

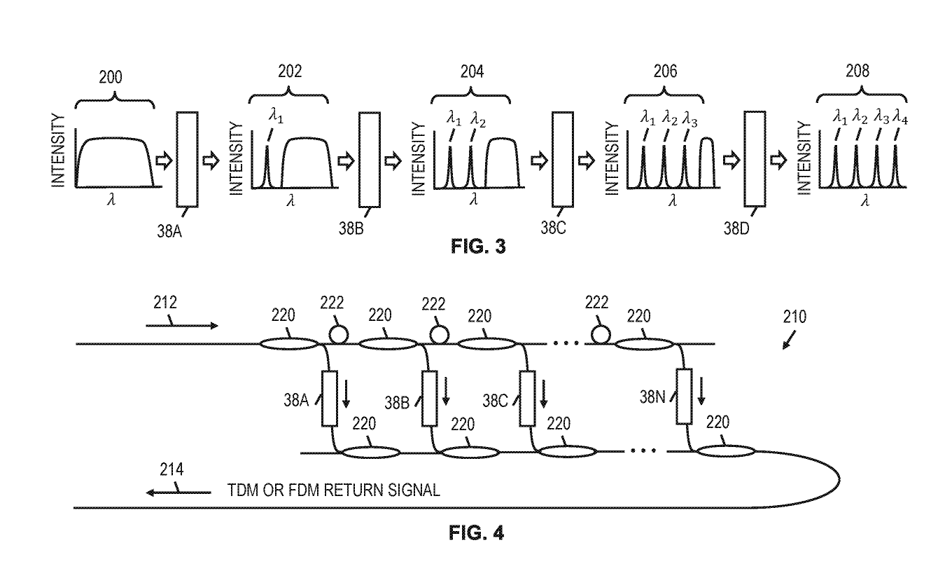

An advantage of such an optical system is that many downhole or subsea sensor units can be connected to a single fiber. A characteristic of this type of optical system is that, by frequency and/or time multiplexing (FDM or TMD), multiple sensors located at different positions along a fiber can provide a measurement with a single wide band light pulse sent from the surface. FIG. 3 shows an optical frequency multiplexing process. As shown, a.

broadband light 200 is input to a first sensor unit 38A. The output 202 of the sensor units 38A includes a pulse (λ₁) corresponding to a gravitational field measurement and a portion of the broadband light 200. Sensor units 38B-38D likewise use a portion of the original broadband signal 200 to provide gravitational field measurements (see λ₂ in output 204, λ₃ in output 206, and λ₄ in output 208). The output 208 include pulses λ₁-λ₄ which respectively encode gravitational field measurements from sensor units 38A-38D. The pulses λ₁-λ₄ are conveyed back to earth's surface. At earth's surface, the pulses λ₁-λ₄ are processed to recover the encoded gravitational field measurements front each of the sensor units 38A-38D. The sensor units 38A-38D may correspond to the sensor units 208A-208N

FIG. 4 shows an optical array of sensor units with a unidirectional configuration 210. In configuration 210, sensor units 38A-38N are positioned along a fiber optic system that includes unidirectional couplers 220 and amplifier portions (e.g., Erbium-doped fiber portions) 222. In response to the input light 212 or portions thereof, the sensor units 38A-38N output optical signals with encoded gravitational field measurements. The output light 214 corresponds to a TDM or FDM return signal with the encoded gravitational field measurements.

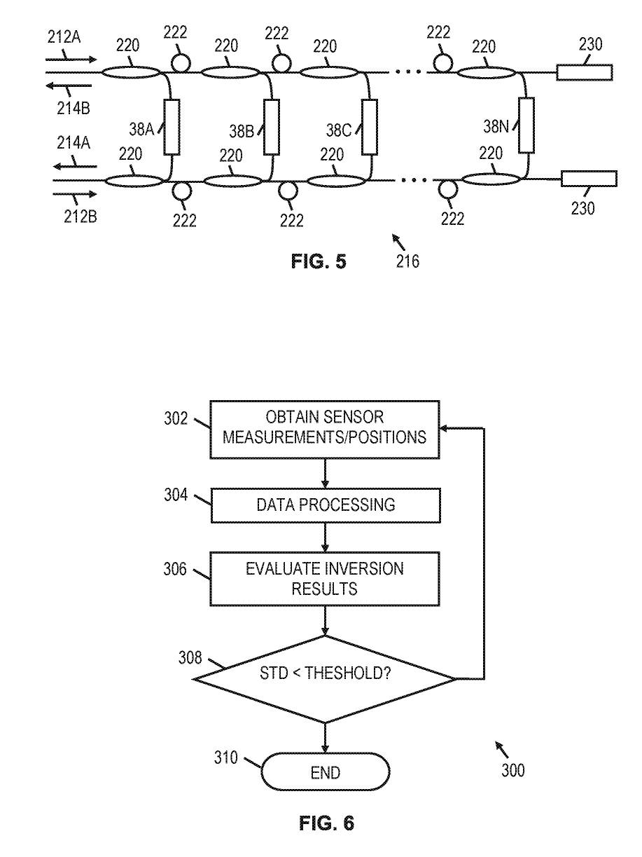

FIG. 5 shows an optical array of sensor units with a bidirectional configuration 216. In configuration 216, sensor units 38A-38N are positioned along a fiber optic system that includes bidirectional couplers 220 and amplifier portions (e.g., Erbium-doped fiber portions) 222. In response to input light 212A or portions thereof, the sensor units 38A-38N output optical signals with encoded gravitational field measurements. The output light 214A corresponds to a TDM and/or FDM return signal with the encoded gravitational field measurements in response to input light 212A. Similarly, in response to input light 212B or portions thereof, the sensor units 38A-38N output optical signals with encoded gravitational field measurements.

The output light 214B corresponds to a TDM and/or FDM return signal with the encoded gravitational field measurements in response to input light 212B. As needed, time delays may be used in configurations 210 and 216 between the optical branches to avoid mixing data from different branches.

For energy efficiency, sensor units can be activated and measurements can be taken periodically. This allows monitoring applications (such as water-flood monitoring), as well as applications where only small number of measurements are required (fracturing). For further efficiency, a different set of sensor units may be activated in different periods. The measurements collected by the sensor units can be correlated with open-hole logs in the same well, if available, for calibration purposes. Ratios or differences of signals from different sensor units can be taken for removing unwanted effects or increasing the sensitivity of the measurement to desired quantities. For example, sensor units 38 that are sufficiently close together may enable error cancellation schemes that improve accuracy of a gravitational field. measurement for a given position related to the closely spaced sensor units 38.

In at least some embodiments, frequency dependent characteristics of the sensor transfer function can be subtracted out by characterizing the frequency dependent characteristics and providing compensation. Through the use of multiple sensor unit positions, orientations nod/or multiple frequencies, a parameterized model of the formation can be inverted. As an example, the disclosed sensing system can be used for monitoring entire fields. Further, with steam-assisted gravity drilling (SAGD) applications, the wells can be drilled at an optimized distance with respect to each other to cover a volume of interest from multiple sides and the data provided by the sensors can be used in an optimal inversion of formation density. Further, in at least some embodiments, at least some of the sensor units correspond to subsea units. For example, such subsea units may be distributed at a number of positions of a sea bed.

FIG. 6 shows a flowchart of an illustrative gravitational logging control process 300. The process 300 may be performed, for example, by a computer (e.g., computer system 20) in communication with one or more of the downhole or subsea sensor units described herein. As shown, the process 300 includes obtaining gravitational sensor measurements and positions at block 302. At block 304, the gravitational sensor measurements and positions are processed (e.g., inverted) to obtain a formation density as a function of position. At block 306, the inversion results are evaluated. For example, an average standard deviation (STD) evaluation may be performed at block 306. If the STD is less than a threshold (decision block 308), the process 300 ends at block 310. Otherwise, the process 300 returns to block 302, where more sensor measurements/positions are obtained. The blocks 302, 304, 306 and 308 of process 300 are repeated as needed until the STD is less than a threshold.

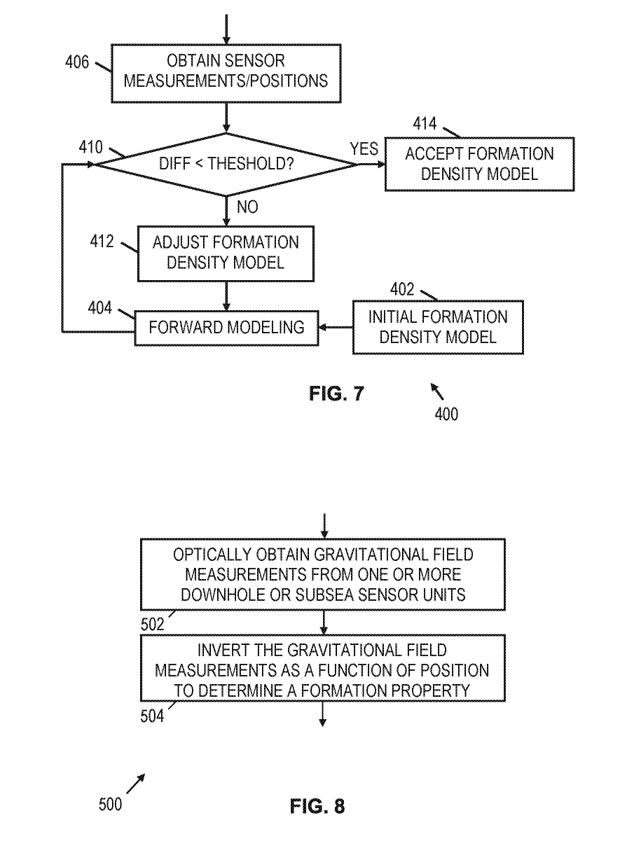

FIG. 7 shows a flowchart of an illustrative gravitational log inversion process 400. The process 400 may be performed, for example, by a computer (e.g., computer system 20) in communication with one or more of the downhole or subsea sensor units described herein. As shown, the process 400 includes performing forward modeling 404 using an initial formation density model 402. The forward modeling block 404 uses the density distribution provided by the initial formation density model 402 to predict gravitational fields representative of that density distribution. As an example, the forward modeling block 404 could use Newton's inverse squared law or an iterative process to approximate the representative gravitational fields.

Further, gravitational sensor measurements and positions are obtained at block 406. At decision block 410, the gravitational field measurements as a function of position obtained at block 406 are compared with the gravitational fields predicted by the forward modeling block 404. If the difference between the gravitational field measurements and predicted gravitational fields are less than a threshold (decision block 410), the current formation density model is accepted. Otherwise, the formation density model is adjusted and the adjusted model is input to the forward modeling block 404. As needed, the process 400 repeats the steps of blocks 404, 406, 410, and 412 until the difference between the gravitational field measurements and the predicted gravitational fields are less than a threshold. In at least some embodiments, the process 400 can also be used to determination of a rate of change in a reservoir. This rate of change information could be used by a gravitational logging control system to increase or decrease the frequency of obtaining gravitational field measurements.

FIG. 8 shows a flowchart of an illustrative gravitational logging method 504. The method 504 may be performed, for example, by a computer (e.g., computer system 20) in communication with one or more of the downhole or subsea sensor units described herein. At block 502, gravitational field measurements are optically obtained from one or more sensor units. For example, the gravitational field measurements may be obtained using any of the survey environments 10A-10D of FIGS. 1A-1D, subsea environments, and any of the gravitational field logging sensor configurations 100A-100G of FIGS. 2A-2G. At block 504, the gravitational field measurements are inverted as a function of position to determine a formation property. For example, block 504 may performed in accordance with processes 300 and 400 of FIGS. 6 and 7.

Embodiments Disclosed Herein Include:

A: A gravitational logging method that comprises optically obtaining gravitational field measurements from one or more downhole or subsea sensor units, and inverting the gravitational field measurements as a function of position to determine a formation property.

B: A gravitational logging system that comprises one or more downhole or subsea sensor units to optically obtain gravitational field measurements, and a processing unit that inverts the gravitational field measurements as a function of position to determine a formation property.

Each of the embodiments, A and B. may have one or more of the following additional elements in any combination. Element 1: optically obtaining gravitational field measurements from the one or more sensor units comprises performing a frequency comparison of first and second optical clock frequencies associated with different atomic optical clocks. Element 2: further comprising repeatedly performing a frequency comparison of the first and second optical clock frequencies until a signal-to-noise ratio reaches a threshold. Element 3: optically obtaining gravitational field measurements from the one or more sensor units comprises performing a time measurement comparison of different atomic optical clocks. Element 4:

further comprising positioning the different atomic optical clocks at different downhole or subsea positions to obtain gravitational field measurements as a function of position. Element 5: further comprising positioning the different atomic optical clocks at different downhole or subsea positions to obtain gravitational field measurements as a function of position. Element 6: further comprising applying a Doppler shift error correction to the gravitational field measurements. Element 7: further comprising applying alight source error correction to the gravitational field measurements. Element 8: optically obtaining gravitational field measurements from one or more sensor units comprises monitoring movement of a pendulum using a light beam. Element 9: optically obtaining gravitational field measurements from one or more sensor units comprises obtaining an electrical signal from a pendulum gravity sensor and converting the electrical signal to an optical signal. Element 10: optically obtaining gravitational field measurements from one or more sensor units comprises obtaining an electrical signal from a rotating gravity gradiometer and converting the electrical signal to an optical signal. Element 11: inverting the gravitational field measurements to determine a formation property comprises inverting at least one of a gravitational potential, a gravitational acceleration, and a gravitational gradient to determine density as a function of position. Element 12: further comprising positioning a plurality of the sensor units based on a predetermined distribution density. Element 13: further comprising changing a position of the one or more sensor units during logging-while-drilling (L′WD) operations or wireline logging operations. Element 14: further comprising halting drilling during logging-while-drilling (LWD) operations and adjusting steering of a bottom-hole assembly based on gravitational field measurements obtained by the sensor units. Element 15: further comprising tracking movement of the one or more sensor units and updating at least some of the gravitational field measurements based on the tracked movement.

Element 16: each of at least two of the sensor units comprise an optical atomic clock to enable a frequency comparison of first and second optical clock frequencies associated with different atomic optical clocks. Element 17: each of at least two of the sensor units comprise an optical atomic clock and electronics to register time values to enable a time comparison of first and second optical clock values associated with different atomic optical clocks. Element 18: each of at least two of the sensor units comprise an optical atomic clock to enable a time comparison of first and second optical clock values associated with different atomic optical clocks. Element 19: at least one of the downhole sensor units comprises a pendulum whose movement is monitored using alight beam. Element 20: at least one of the sensor units comprises a pendulum gravity sensor and an electro-optical transducer to convert an output of the pendulum gravity sensor to an optical signal. Element 21: at least one of the sensor units comprises a rotating gravity gradiometer and an electro-optical transducer to convert an output of the rotating gravity gradiometer to an optical signal. Element 22: the processing unit inverts at least one of a gravitational potential, a gravitational acceleration, and a gravitational gradient obtained from the one or more sensor units to determine density as a function of position.

Numerous other variations and modifications will become apparent to those skilled in the art once the above disclosure is fully appreciated. It is intended that the following claims be interpreted to embrace all such variations and modifications where applicable.

1. A gravitational logging method, comprising:
obtaining gravitational field measurements from one or more downhole or subsea sensor units, wherein said obtaining comprises altering wavelengths of optical signals corresponding to the gravitational field measurements and conveying the altered optical signals via an optical fiber;
recovering the gravitational field measurements from the altered optical signals; and
inverting the recovered gravitational field measurements as a function of position to determine a formation property.

2. The method of claim 1, wherein obtaining gravitational field measurements from the one or more sensor units comprises performing a frequency comparison of first and second optical clock frequencies associated with different atomic optical clocks.

3. The method of claim 2, further comprising repeatedly performing a frequency comparison of the first and second optical clock frequencies until a signal-to-noise ratio reaches a threshold.

4. The method of claim 2, wherein obtaining gravitational field measurements from the one or more sensor units comprises performing a time measurement comparison of different atomic optical clocks.

5. The method of claim 2, further comprising positioning the different atomic optical clocks at different downhole or subsea positions to obtain gravitational field measurements as a function of position.

6. The method of claim 1, further comprising moving an atomic optical clock to different downhole or subsea positions to obtain gravitational field measurements as a function of position.

7. The method of claim 1, further comprising applying a Doppler shift error correction to the gravitational field measurements.

8. The method of claim 1, further comprising applying a light source error correction to the gravitational field measurements.

9. The method of claim 1, wherein obtaining gravitational field measurements from the one or more sensor units comprises monitoring movement of a pendulum using a light beam.

10. The method of claim 1, wherein obtaining gravitational field measurements from the one or more sensor units comprises obtaining an electrical signal from a pendulum gravity sensor and converting the electrical signal to an optical signal.

11. The method of claim 1, wherein obtaining gravitational field measurements from the one or more sensor units comprises obtaining an electrical signal from a rotating gravity gradiometer and converting the electrical signal to an optical signal.

12. The method of claim 1, wherein inverting the gravitational field measurements to determine a formation property comprises inverting at least one of a gravitational potential, a gravitational acceleration, and a gravitational gradient to determine density as a function of position.

13. The method of claim 1, further comprising positioning a plurality of the sensor units based on a predetermined distribution density.

14. The method of claim 1, further comprising changing a position of the one or more sensor units during logging-while-drilling (LWD) operations or wireline logging operations.

15. The method of claim 1, further comprising halting drilling during logging-while-drilling (LWD) operations and adjusting steering of a bottom-hole assembly based on gravitational field measurements obtained by the sensor units.

16. The method of claim 1, further comprising tracking movement of the one or more sensor units and updating at least some of the gravitational field measurements based on the tracked movement.

17. A gravitational logging system, comprising:
one or more downhole or subsea sensor units to obtain gravitational field measurements;
optical components to alter wavelengths of optical signals corresponding to the gravitational field measurements;
an optical fiber to convey the altered optical signals to a surface interface configured to recover the gravitational field measurements; and
a processing unit that inverts the recovered gravitational field measurements as a function of position to determine a formation property.

18. The gravitational logging system of claim 17, wherein each of at least two of the sensor units comprise an optical atomic clock to enable a frequency comparison of first and second optical clock frequencies associated with different atomic optical clocks.

19. The gravitational logging system of claim 17, wherein each of at least two of the sensor units comprise an optical atomic clock and electronics to register time values to enable a time comparison of first and second optical clock values associated with different atomic optical clocks.

20. The gravitational logging system of claim 17, wherein each of at least two of the sensor units comprise an optical atomic clock to enable a time comparison of first and second optical clock values associated with different atomic optical clocks.

21. The gravitational logging system of claim 17, wherein at least one of the sensor units comprises a pendulum whose movement is monitored using a light beam.

22. The gravitational logging system of claim 17, wherein at least one of the sensor units comprises a pendulum gravity sensor and an electro-optical transducer to convert an output of the pendulum gravity sensor to an optical signal.

23. The gravitational logging system of claim 17, wherein at least one of the sensor units comprises a rotating gravity gradiometer and an electro-optical transducer to convert an output of the rotating gravity gradiometer to an optical signal.

24. The gravitational logging system of claim 17, wherein the processing unit inverts at least one of a gravitational potential, a gravitational acceleration, and a gravitational gradient obtained from the one or more sensor units to determine density as a function of position.

25. The method of claim 1, wherein said conveying the altered optical signals comprises sending the altered optical signals to earth's surface and wherein said recovering the gravitational field measurements involves use of an interferometer.

26. The gravitational logging system of claim 17, wherein said processing unit is located at earth's surface.
